(19) United States
(12) Patent Application Publication
(10) Pub. No.: US 2015/0360521 A1
(43) Pub. Date: Dec. 17, 2015

(54) PNEUMATIC TIRE

(71) Applicant: The Yokohama Rubber Co., Ltd., Tokyo (JP)

(72) Inventors: Hiroyuki KOJIMA, Tokyo (JP); Hiroshi TOKIZAKI, Tokyo (JP)

(21) Appl. No.: 14/834,037

(22) Filed: Aug. 24, 2015

Related U.S. Application Data
(62) Division of application No. 12/910,526, filed on Oct. 22, 2010.

(51) Int. Cl. B60C 13/02; B60C 5/00

(52) U.S. Cl. CPC B60C 13/02; B60C 5/00

(57) ABSTRACT

A pneumatic tire includes: a plurality of projections provided on a tire outer side surface of the pneumatic tire, wherein each of the projections has a height in a range from 0.5 mm to 4 mm and a maximum height at a position outer, in the tire radial direction, than a position where a tire total width is maximum, and wherein the pneumatic tire includes: an outer diameter and a total width excluding the projections are set to fall within ranges from 0 mm to 6 mm with respect to lower limits of standard dimensions in a state where the pneumatic tire is fitted to a standard rim and a normal internal pressure is applied; and a tread ground contact width at 60% load being set to fall within a range from 60% to 75% of the total width excluding the projections.

### BACKGROUND

1. Field

The present invention relates to a pneumatic tire to be used for, for example, passenger cars, trucks, and buses.

2. Description of the Related Art

In recent years, in conjunction with the higher performance of automobiles, various performance has also been required of tires, and on the other hand, in order to realize resource saving and reduce the amount of exhaust, development of a tire with excellent fuel efficiency has been demanded. In order to increase fuel efficiency, reduction in the rolling resistance of a tire is important, however, the rolling resistance depends on the material and rigidity, etc., of rubber, so that there is a limitation to improving the rolling resistance. As shown in FIG. 10, when the speed of a vehicle (rotation speed of tire) increases, the rolling resistance also increases, and additionally, the air resistance of a tire also increases and this leads to a deterioration in fuel efficiency.

Therefore, there is known a tire in which, in order to reduce air resistance, on the buttress portion from the tread end portion to the side wall portion, a turbulence preventing region having no irregularities such as grooves, patterns, and characters is provided to prevent turbulence at the buttress portion, and accordingly, air resistance on the tire surface is reduced. An example of such configuration is disclosed in JP-A-2003-127615.

However, when a measure is taken for preventing turbulence from occurring at the buttress portion, the air flow around a tire becomes a laminar flow, so that the rear of a tire when a vehicle travels becomes low in pressure, and a force that pulls back the tire rearward acts. Therefore, even if air resistance on a tire surface is reduced, a low-pressure portion is brought about at the rear of a tire, so that an air resistance reducing effect when traveling at a high speed cannot be sufficiently obtained.

### SUMMARY

One of objects of the present invention is to provide a pneumatic tire which is capable of effectively reducing air resistance when traveling at a high speed.

According to an aspect of the invention, there is provided a pneumatic tire including: a plurality of projections provided on a tire outer side surface of the pneumatic tire, the projections extending in a tire radial direction and having an interval between each of the projections in a tire circumferential direction, at intervals in the tire circumferential direction on the tire outer side surface, wherein each of the projections has a height in a range from 0.5 mm to 4 mm and a maximum height at a position outer, in the tire radial direction, than a position where a tire total width is maximum, and wherein the pneumatic tire includes: an outer diameter and a total width excluding the projections are set to fall within ranges from 0 mm to 6 mm with respect to lower limits of standard dimensions in a state where the pneumatic tire is fitted to a standard rim and a normal internal pressure is applied; and a tread ground contact width at 60% load being set to fall within a range from 60% to 75% of the total width excluding the projections.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a partial front sectional view of a pneumatic tire showing a first embodiment of the present invention.

FIG. 2 is a partial front sectional view of the pneumatic tire showing a ground contact state.

FIG. 3 is a front sectional view of the pneumatic tire.

FIG. 4 is a partial side view of the pneumatic tire.

FIG. 5 is an essential portion sectional view of the pneumatic tire.

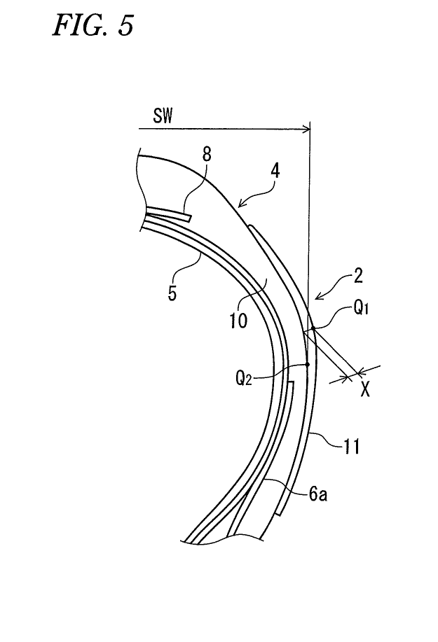

FIG. 6 is a sectional view of a projection along a line VI-VI shown in FIG. 4.

FIG. 7 is an essential portion sectional view of a pneumatic tire showing a second embodiment of the present invention.

FIG. 8 is a partial side view of a pneumatic tire showing a third embodiment of the present invention.

FIGS. 9A and 9B are sectional views showing exemplary variations of the projection.

FIG. 10 is a partial front sectional view of a pneumatic tire showing a fourth embodiment of the present invention.

FIG. 11 is a partial side view of the pneumatic tire.

FIG. 12 is a partial side view of a pneumatic tire showing a fifth embodiment of the present invention.

FIG. 13 is a partial front sectional view of a pneumatic tire showing a sixth embodiment of the present invention.

FIGS. 14A and 14B are side sectionals views showing exemplary variations of a recess.

FIGS. 15A and 15B are schematic views showing an air flow around the tire.

FIG. 16 is a table showing test results.

FIG. 17 is a view showing the correlation between the speed and rolling resistance, and air resistance.

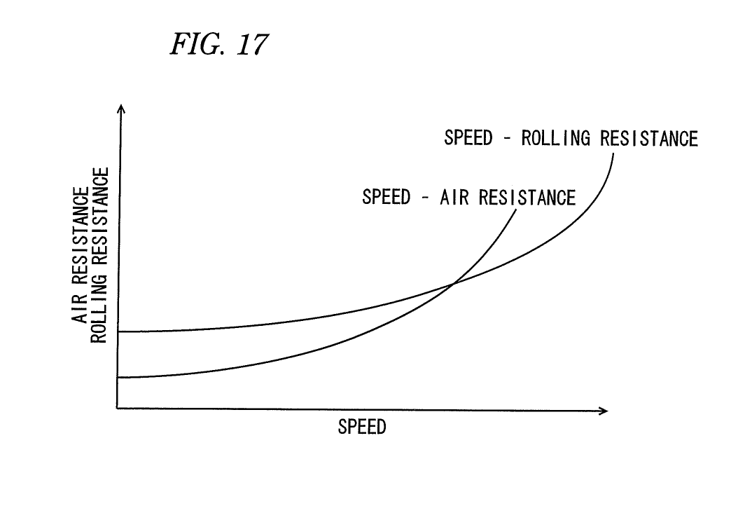

### DETAILED DESCRIPTION OF THE EMBODIMENTS

Embodiments according to the present invention will be described in detail with reference to the accompanying drawings. The scope of the claimed invention should not be limited to the examples illustrated in the drawings and those described in below.

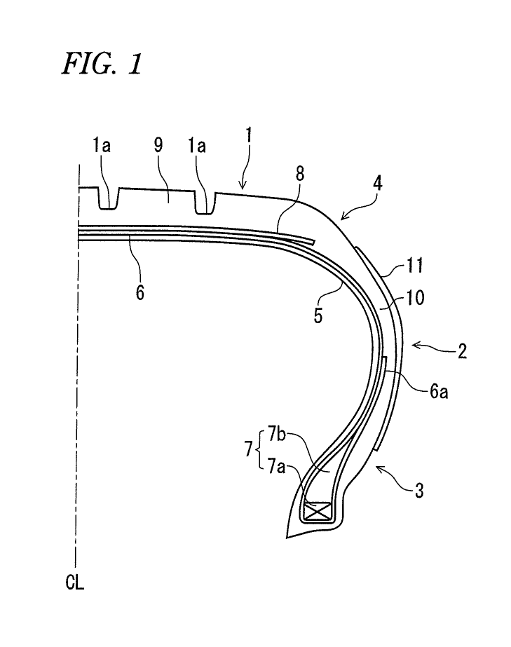

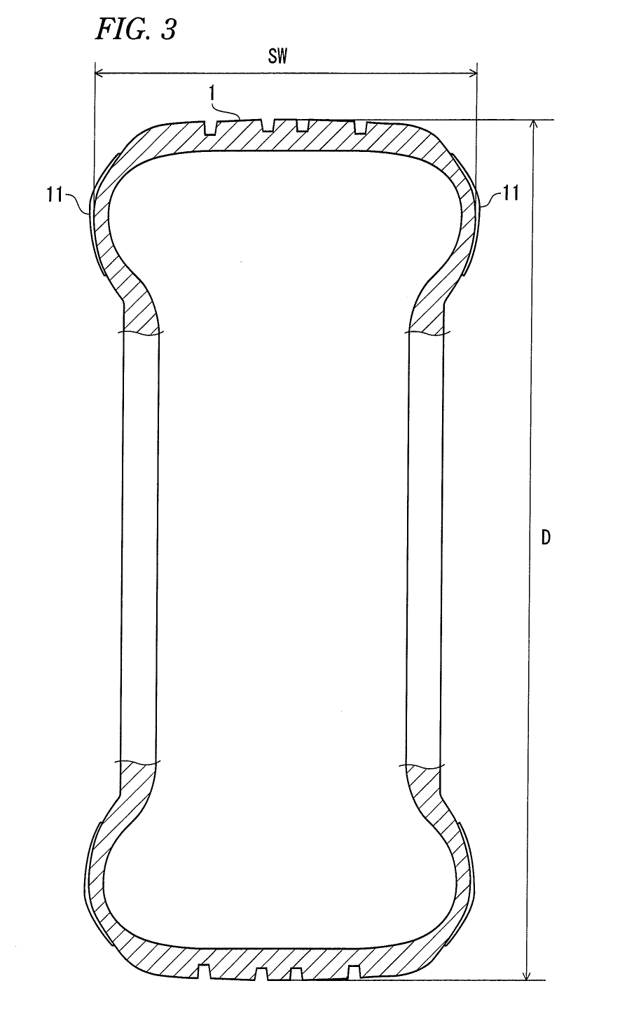

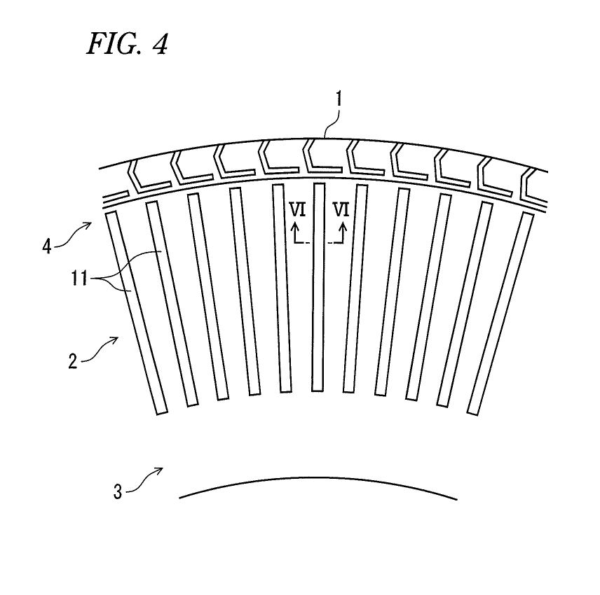

Hereinafter, a first embodiment of the present invention will be described with reference to FIG. 1 to FIG. 4. The pneumatic tire shown in these drawings includes a tread portion 1 formed on the tire outer peripheral surface side, a pair of side wall portions 2 formed on both sides in the tire width direction, a pair of bead portions 3 formed on both sides in the tire width direction, and buttress portions 4 formed between the tread portion 1 and the side wall portions 2.

This pneumatic tire is formed by an inner liner 5 disposed on the tire inner surface side, a carcass member 6 disposed on the outer side of the inner liner 5, a pair of bead members 7 disposed on both sides in the tire width direction, a belt 8 disposed on the outer side of the carcass member 6, a tread member 9 disposed on the tire outer peripheral surface side, and a pair of side wall members 10 disposed on both side surface sides of the tire.

The inner liner 5 is formed of a sheet-like rubber with low gas permeability as a main material, and disposed on the inner peripheral surface side of the carcass member 6.

The carcass member 6 is formed by covering a plurality of reinforcement cords 6a by a sheet-like rubber, and both end sides are folded back to the side wall portion 2 sides from the inner side to the outer side in the tire width direction so as to roll the bead members together.

The bead member 7 includes a bead core 7a formed by bundling wires such as metal wires, and a bead filler 7b formed of rubber having a substantially triangular sectional shape, and the bead filler 7b is disposed on the outer peripheral side of the bead core 7a.

The belt 8 is formed by covering a belt cord made of steel or high-strength fibers, etc., by a sheet-like rubber, and is disposed on the outer peripheral surface side of the carcass member 6.

The tread member 9 is made of rubber formed by extrusion molding, and disposed to cover the central side in the width direction of the carcass member 6 and the outer peripheral surface side of the belt 8, and on the outer peripheral surface of the tread member, grooves la forming a tread pattern are formed at the time of vulcanization molding.

The side wall members 10 are made of rubber formed by extrusion molding, and are disposed so as to cover both sides in the tire width direction of the carcass member 6.

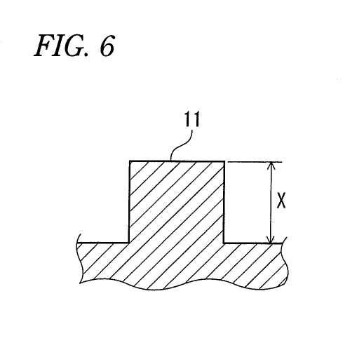

On the outer side surfaces of the pneumatic tire, a large number of projections 11 extending with uniform widths in the tire radial directions are provided, and the projections 11 are disposed at even intervals in the tire circumferential direction. As shown in FIG. 6, each projection 11 is formed to have a quadrilateral sectional shape orthogonal to the tire radial direction, and have a height X not less than 0.5 mm and not more than 4mm orthogonal to the tire surface. In this case, each projection 11 is formed so that its height X becomes higher on the central portion in the longitudinal direction than on both end portions in the longitudinal direction, and the portion Q1 where the height becomes the maximum of the projection is positioned closer to the outer side in the tire radial direction than the portion Q2 where the tire total width SW becomes the maximum excluding the projection 11. The projections 11 do not include projections formed of characters, symbols, and emblems indicated on the tire side surface.

The pneumatic tire is formed so that the outer diameter D and the total width SW excluding the projections 11 in the state where the tire is fitted to a standard rim regulated by JATMA standards, ETRTO standards, or TRA standards and a normal internal pressure is applied fall within ranges not less than 0 mm and not more than 6 mm with respect to the lower limits of the standard dimensions. Here, the standard dimensions are the outer diameter and the total width regulated by JATMA standards, ETRTO standards, or TRA standards. However, JATMA standards do not regulate the lower limit of the total width, so that the lower limit regulated by ETRTO standards is used as the lower limit of the total width.

Further, the pneumatic tire is formed so that the tread ground contact width TW at 60% load becomes not less than 60% and not more than 75% of the total width SW excluding the projections 11.

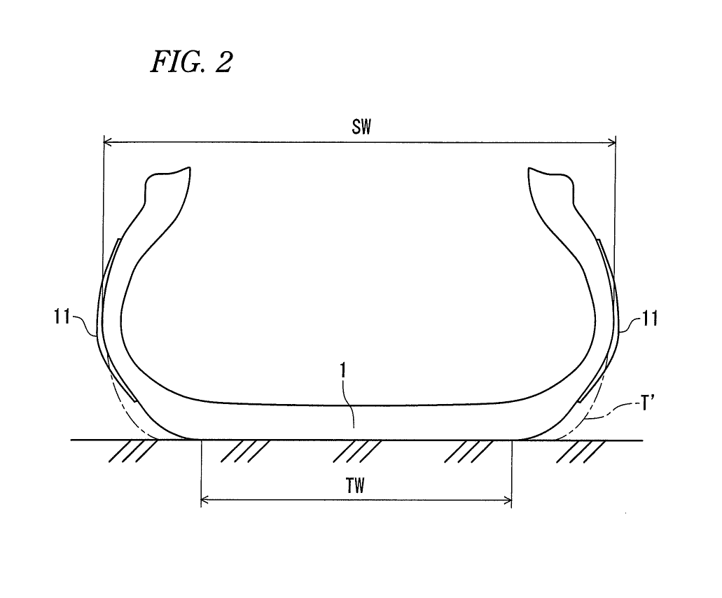

The pneumatic tire of the present embodiment is formed so that the outer diameter D and the total width SW fall within ranges not less than 0 mm and not more than 6 mm with respect to the lower limits of the standard dimensions, so that the outer diameter D and the total width SW are set to the minimum dimensions within ranges of the standard dimensions or close to the minimum dimensions, and the forward projection area becomes smaller than that of a tire having an outer diameter and a total width larger than the ranges. Further, the tire is formed so that the tread ground contact width TW becomes not less than 60% and not more than 75% of the total width SW, and therefore, the forward projection area becomes smaller than that of a tire T′ (alternate long and short dashed line of FIG. 2) having a tread ground contact width larger than the range. Further, the air flow around the tire when the vehicle travels is accelerated by a large number of projections 11 provided on the tire outer side surfaces. In this case, the revolution speed becomes relatively higher on the outer side in the tire radial direction than on the inner side in the tire radial direction, and the portion Q1 where the height X becomes the maximum of the projection 11 is positioned closer to the outer side in the tire radial direction than the portion Q2 where the tire total width SW becomes the maximum, so that the air rectifying effect of the projections 11 is increased.

The pneumatic tire of the present embodiment is formed so that the outer diameter D and the total width SW fall within ranges not less than 0 mm and not more than 6 mm with respect to the lower limits of the standard dimensions, and the tread ground contact width TW becomes not less than 60% and not more than 75% of the total width SW, so that the forward projection area can be made smaller, and the air resistance when traveling at a high speed can be effectively reduced. In particular, the ground contact surface side of the tire is not covered by the front surface of the vehicle, so that by reducing the tread ground contact width TW with respect to the total width SW, the forward projection area on the ground contact surface side can be made smaller as shown in FIG. 2, and this is very advantageous for reduction in air resistance. Further, a large number of projections 11 extending in the tire radial directions are provided at intervals in the tire circumferential direction on the tire outer side surfaces, and the portion Q1 where the height X of the projection 11 becomes the maximum is positioned closer to the outer side in the tire radial direction than the portion Q2 where the tire total width SW becomes the maximum, so that the air flow around the tire when the vehicle travels can be accelerated by the projections 11, and the air resistance of the tire when traveling at a high speed can be more effectively reduced.

In this case, each projection 11 is formed to have a height X not less than 0.5 mm and not more than 4 mm, so that it is prevented that the height becomes excessively low and makes the air rectifying effect insufficient and the height becomes excessively high and increases the air resistance of the tire.

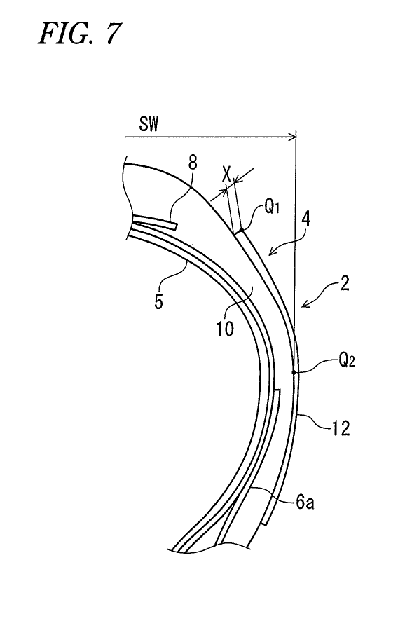

In the embodiment described above, the projections 11 the heights X of which become the maximum at their central portions in the longitudinal directions are shown, however, it is also possible that the heights X become the maximum at the outer side end portions in the tire radial directions like the projection 12 shown in the second embodiment of FIG. 7.

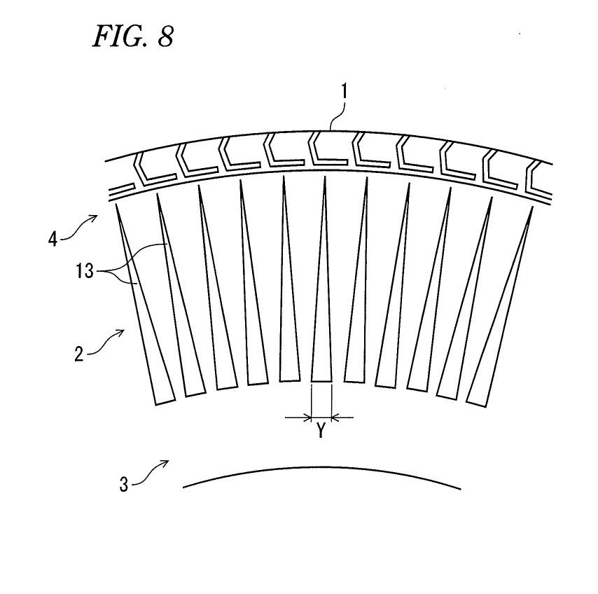

In the first embodiment, the projections 11 formed to extend with uniform widths in the tire radial directions are shown, however, the projections may be formed to increase their widths Y toward the inner side in the tire radial direction like the projections 13 shown in the third embodiment of FIG. 8. Specifically, on the tire side surface, the rubber thickness is thinner on the outer side (buttress portion 4 side) in the tire radial direction than on the inner side (bead portion 3 side) in the tire radial direction, so that if the amount of flow of the rubber on the buttress portion 4 side to the mold side of each projection 11 is large at the time of vulcanization molding, the rubber thickness on the buttress portion 4 side becomes thinner and deflection increases, however, by reducing the width Y on the outer side in the tire radial direction of each projection 11, the amount of flow of the rubber on the buttress portion 4 side to each projection 11 side at the time of vulcanization molding can be reduced, and the rubber thickness on the buttress portion 4 side can be prevented from becoming thinner.

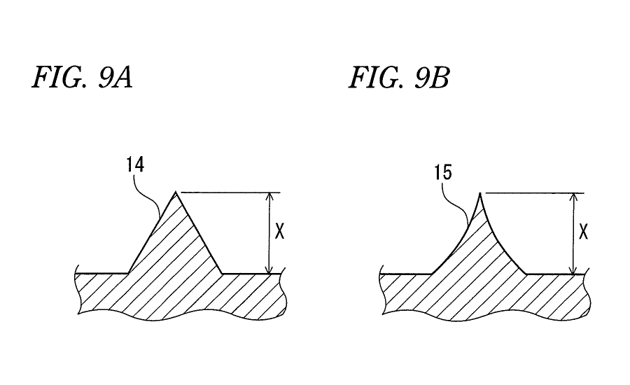

Further, in the first embodiment described above, the projections 11 formed to have quadrilateral sectional shapes orthogonal to the tire radial directions are shown, however, the projections may be formed to have mountain shapes (triangular shapes) like the projection 14 shown in the exemplary variation of FIG. 9A. Accordingly, the volume of the projection 14 is made smaller than that of the quadrilateral projection, and accordingly, the rubber usage can be reduced by that amount, and this weight reduction leads to improvement in fuel efficiency. In this case, by forming each projection so that the two sides of the mountain shape form a concave shape inward like the projection 15 shown in another exemplary variation of FIG. 9B, the volume of the projection 15 can be further reduced.

In the state where the tire is fitted to a vehicle, on the outer side in the width direction of the vehicle, air uniformly flows rearward, however, on the inner side in the width direction of the vehicle, the tire is disposed inside a tire house and other components such as axles are disposed around, so that the air flow is easily disrupted. Therefore, the air ventilation acceleration effect and the rectifying effect due to the projections 11 (12, 13, 14, 15) can be sufficiently obtained only on the inner side in the width direction of the vehicle on which the air flow is easily disrupted, so that it is also allowed that the projections 11 (12, 13, 14, 15) are provided on one side surface in the tire width direction which becomes the inner side in the width direction of the vehicle when the tire is fitted to the vehicle. Accordingly, the cost of the mold for forming the projections 11 (12, 13, 14, 15) can be reduced.

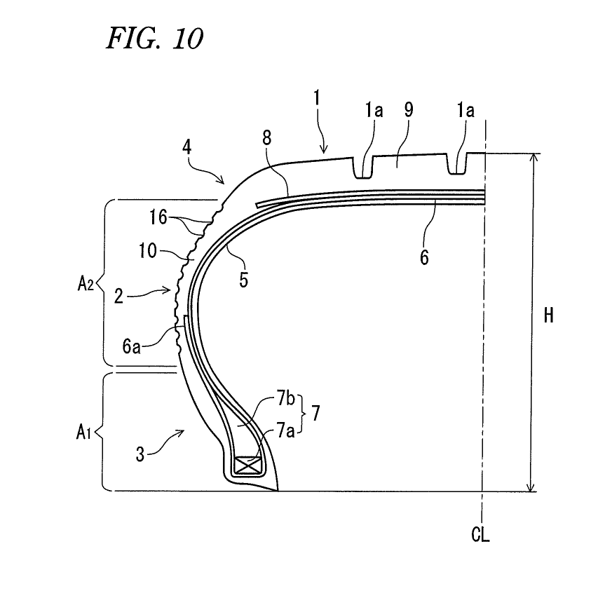

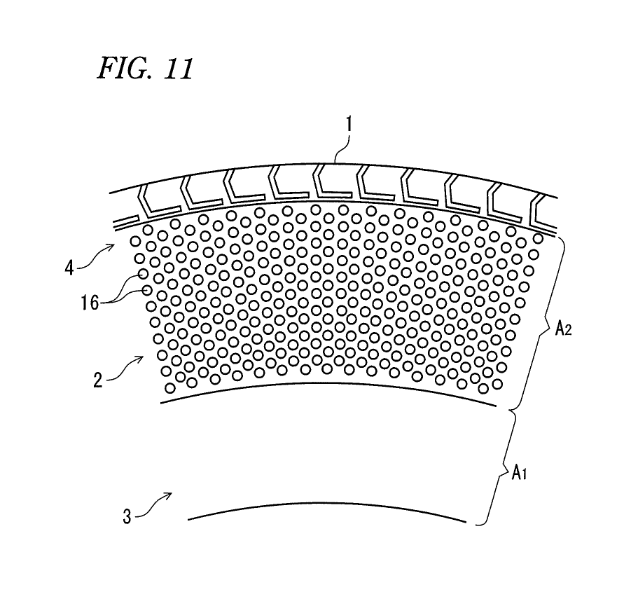

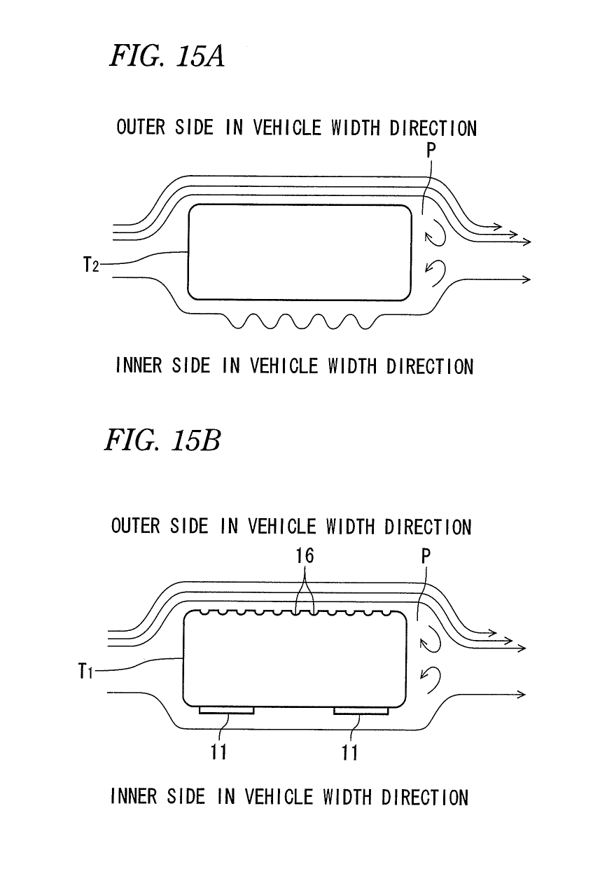

In this case, on the other side surface in the tire width direction which becomes the outer side in the width direction of the vehicle when the tire is fitted to the vehicle, as shown in the fourth embodiment of FIG. 10 and FIG. 11, a large number of recesses 16 may be provided in the tire circumferential direction and the tire radial directions in a predetermined second region A2 (for example, a range not less than 35% and not more than 85% of the tire cross-section height H from the inner side end portion in the tire radial direction) except for a first region A1 within 35% of the tire cross-section height H from the inner side end portion in the tire radial direction. The tire cross-section height is a tire cross-section height in the state where a normal internal pressure regulated by JATMA standards, ETRTO standards, or TRA standards is filled in the tire, and a normal load regulated by the same standards is applied. The recesses 16 are formed into circular spherical shapes with a diameter not less than 0.5 mm and not more than 8 mm and a maximum depth not less than 0.3 mm and not more than 2 mm, and are formed into the same size and disposed at even intervals. In this case, the recesses 16 are formed so that the total area (the entire area of all recesses 16 on the tire surface) becomes not less than 10% and not more than 80% with respect to the second region A2. The recesses 16 do not include recesses of characters, symbols, or emblems indicated on the tire side surface. Accordingly, turbulence is generated around the tire due to the recesses 16 when the vehicle travels, and as shown in FIG. 15A and FIG. 15B, a low-pressure portion P (region with a lower air density) caused at the rear of the tire T1 having the recesses 16 can be made smaller than that of the tire T2 having no recesses 16, and accordingly, the drag (force that pulls back the tire rearward) due to the low-pressure portion P can be made smaller by only that amount, so that the air resistance of the tire when traveling at a high speed can be more effectively reduced. At this time, on the inner side in the width direction of the vehicle, the air ventilation acceleration effect is generated by the projections 11, so that the air resistance reducing effect can be increased synergistically by the projections 11 and the recesses 16.

In this case, the recesses 16 are provided in the second region A2 except for the first region A1 within 35% of the tire cross-section height from the inner side end portion in the tire radial direction, so that the recesses 16 can be disposed on the outer side in the tire radial direction on which the revolution speed becomes relatively higher than on the inner side in the tire radial direction, so that the turbulence generating effect of the recesses 16 can be further increased.

Each recess 16 is formed to have a depth not less than 0.3 mm and not more than 2 mm, so that it is prevented that the depth becomes excessively small and makes the turbulence generating effect insufficient and the depth becomes excessively large and increases the air resistance.

Further, each recess 16 is formed into a circular shape with a diameter not less than 0.5 mm and not more than 8 mm, so that it is prevented that each recess 16 is excessively small and makes insufficient the turbulence generating effect and is excessively large and increases the air resistance.

In the fourth embodiment described above, a tire with recesses 16 formed into circular shapes is shown, however, they may be formed into other shapes such as oval or polygonal shapes. In this case, when they have oval shapes, the average of the longer axis and the shorter axis of the oval shape is set as the diameter of the recess, and in the case of polygonal shapes, the outer diameter of the circumscribed circle is set as the diameter of the recess so that the diameters become not less than 0.5 mm and not more than 8 mm.

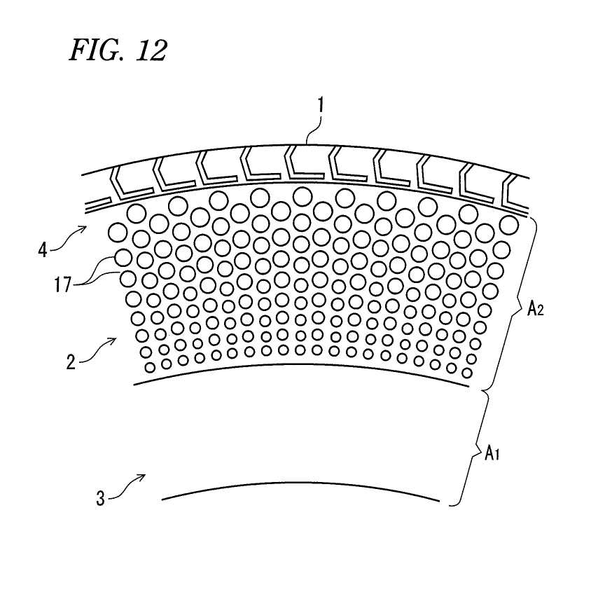

In the fourth embodiment described above, a tire with recesses 16 having the same size is shown, however, the recesses may be formed so that the closer the position to the outer side in the tire radial direction, the larger the size like the recesses 17 shown in the fifth embodiment of FIG. 12. Specifically, by disposing larger recesses 17 on the outer side in the tire radial direction on which the revolution speed becomes relatively higher than on the inner side in the tire radial direction, the turbulence generating effect can be further increased and a great separation phenomenon can be further suppressed, so that this is very advantageous for reduction in air resistance.

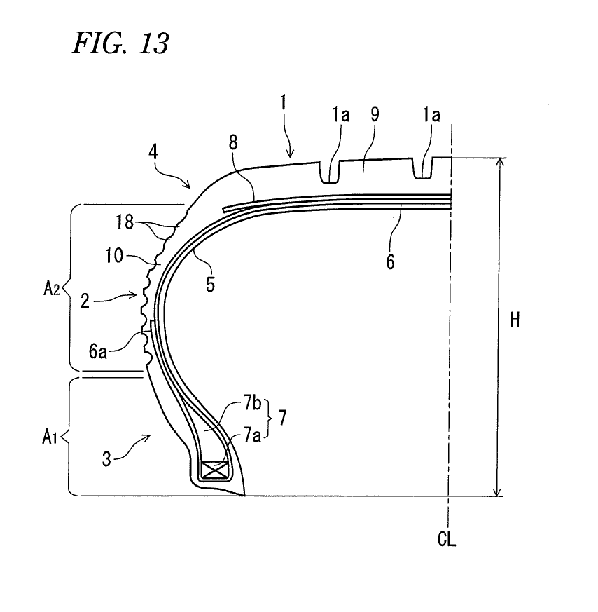

Further, in the fourth embodiment described above, a tire with recesses 16 having the same depth is shown, however, the recesses may be formed so that the closer the position to the outer side in the tire radial direction, the smaller the depth like the recesses 18 shown in the sixth embodiment of FIG. 13. Specifically, by disposing recesses 18 with smaller depths on the outer side in the tire radial direction on which the revolution speed becomes relatively higher than on the inner side in the tire radial direction, the turbulence generating effect can be further increased and a great separation phenomenon can be further suppressed, so that this is very advantageous for reduction in air resistance.

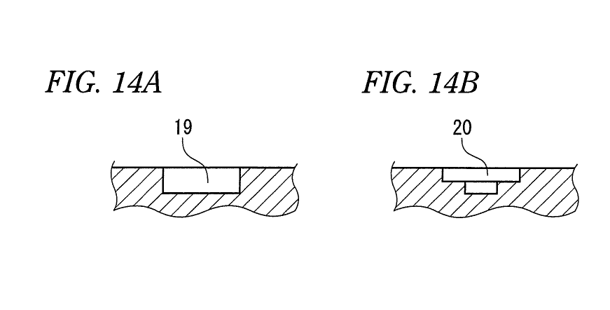

In the embodiments described above, recesses 16 formed into spherical shapes are shown, however, they may be formed to have quadrilateral sectional shapes like the recess 19 shown in FIG. 14A, or may be formed into a double-deck shape including quadrilateral sectional shapes different in size like the recess 20 shown in FIG. 14B.

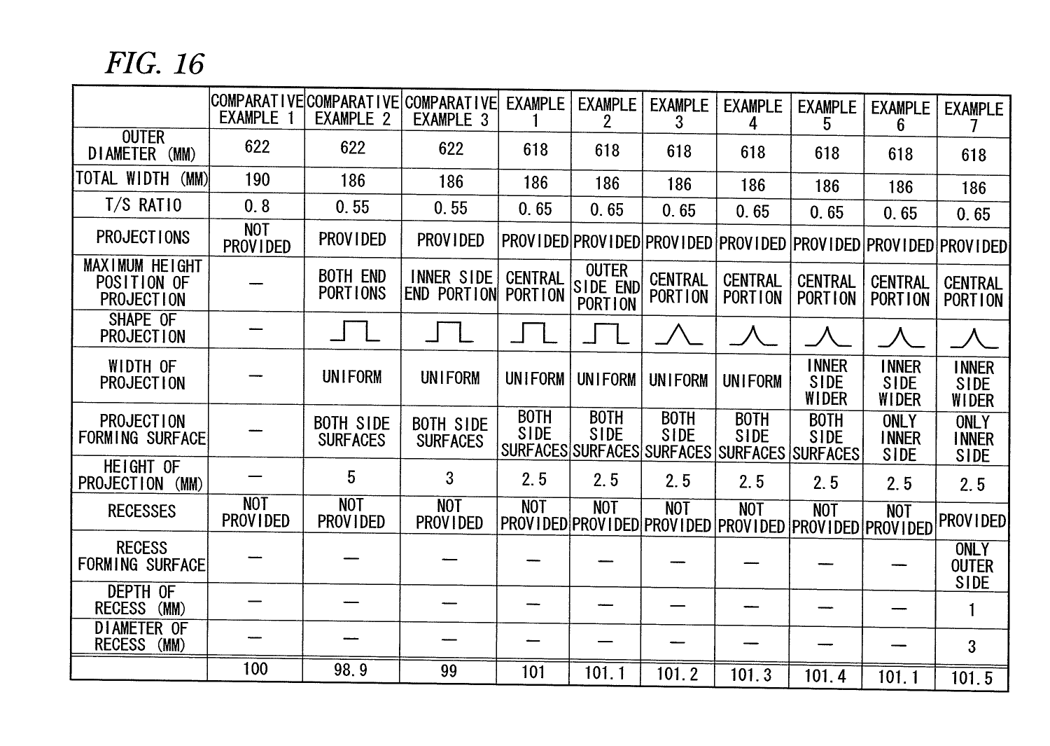

Here, a fuel efficiency test was conducted for Examples 1 to 7 of the present invention and Comparative examples 1 to 3, and the results shown in FIG. 16 were obtained. In this test, tires with outer diameters more than 6 mm larger than the lower limit of the standard dimension were used in Comparative examples 1 to 3, and tires with outer diameters not more than 6 mm larger than the lower limit of the standard dimension were used in Examples 1 to 7. Further, in Comparative example 1, a tire with a total width more than 6 mm larger than the lower limit of the standard dimension was used, and tires with total widths not more than 6 mm larger than the lower limit of the standard dimension were used in Comparative examples 2 and 3 and Examples 1 to 7. Further, in Comparative example 1, a tire having a value (T/S ratio) more than 0.7 obtained by dividing a tread ground contact width at 60% load by a total width when a normal inner pressure is applied and the tire is fitted to a standard rim was used, and in Comparative examples 2 and 3, tires with T/S ratios less than 0.65 were used, and in Examples 1 to 7, tires with T/S ratios not less than 0.65 and not more than 0.7 were used. A tire without projections was used in Comparative example 1, tires with projections having quadrilateral sectional shapes were used in Comparative examples 2 and 3 and Examples 1 and 2, a tire with projections having triangular sectional shapes was used in Example 3, and tires with projections having mountain shapes the two sides of which form a concave shape inward were used in Examples 4 to 7. In this case, in Examples 5 to 7, tires with projections the widths of which become wider toward the inner side in the tire radial directions were used. Further, a tire with projections the maximum height positions of which are on both end portions in the longitudinal directions was used as Comparative example 2, and a tire with projections the maximum height positions of which are on the inner side end portions in the tire radial directions was used in Comparative example 3, tires with projections the maximum height positions of which are on the central portions in the longitudinal directions (closer to the outer side in the tire radial directions than the portion where the tire total width becomes the maximum) was used in Example 1 and Examples 3 to 7, and a tire with projections the maximum height positions of which are on the outer side end portions in the tire radial directions was used in Example 2. A tire with projections the maximum heights of which are more than 4 mm was used in Comparative example 2, tires with projections the maximum heights of which are not more than 4 mm were used in Comparative example 3 and Examples 1 to 7. Further, tires with projections provided on both side surfaces in the tire width direction were used in Comparative examples 2 and 3 and Examples 1 to 5, and tires with projections provided only on one side surface in the tire width direction which becomes the inner side in the width direction of a vehicle when the tires are fitted to the vehicle were used in Examples 6 and 7. In this case, a tire with circular recesses provided on the other side surface in the tire width direction which becomes the outer side in the width direction of a vehicle when the tire is fitted to the vehicle was used in Example 7. In Example 7, a tire with recesses provided in a region except for a range within 35% of the tire cross-section height from the inner side end portion in the tire radial direction was used.

In this test, a tire size of 185/65R15 was used, and in the case of this size, according to JATMA standards, the standard outer diameter is 614 mm to 628 mm and the standard total width (ETRTO standards were applied to the lower limit) is 182 mm to 197 mm, and according to ETRTO standards, the standard outer diameter is 614 mm to 628 mm and the standard total width is 182 mm to 196 mm, and according to TRA standards, the standard outer diameter is 614 mm to 628 mm and the standard total width is 182 mm to 194 mm.

In this test, a tire with an air pressure of 230 kPa was fitted to a (motor-assisted) small passenger car (front-wheel drive) of 1500 cc displacement, and fuel consumption when the car travels ten laps of a 2 km long test course at a speed of 100 km/h was measured and indexed, and Comparative examples 2 and 3 and Examples 1 to 7 were evaluated by defining Comparative example 1 as 100. In this case, the larger the index, the higher the superiority. As a result of the test, Examples 1 to 7 are superior in fuel efficiency to Comparative examples 1 to 3.

As described in the above, there is provided a pneumatic tire having smaller forward projection area. Accordingly, the air flow around the tire when traveling can be accelerated, so that the air resistance when traveling at a high speed can be effectively reduced, and this is very advantageous in terms of improvement in fuel efficiency.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

1-11. (canceled)

12. A pneumatic tire comprising:
a plurality of projections, the projections being provided on an outer side of the pneumatic tire,
wherein each of the projections extends in a tire radial direction, thereby defining a height of each of the projections,
the projections form a pattern extending in a tire circumferential direction, and an interval is provided between any two of the projections adjacently paired in the tire circumferential direction,
the height of each of the projections is in a range from 0.5 mm to 4 mm, and a maximum height of the projections is positioned radially outward of a position where a total width of the pneumatic tire is the maximum;
an outer diameter of the pneumatic tire excluding the projections are set to fall within a range from 0 mm to 8 mm with respect to lower limits of standard dimensions in a state where the pneumatic tire is fitted to a standard rim and a normal internal pressure is applied, wherein the standard dimensions, the standard rim, and the normal internal pressure are as defined by the Japan Automobile Tire Manufacturers Association (JATMA) standards, the European Tyre and Rim Technical Organization (ETRTO) standards, or the Tire and Rim Association (TRA) standards;
the total width of the pneumatic tire excluding the projections are set to fall within a range from 0 mm to 6 mm with respect to lower limits of standard dimensions in a state where the pneumatic tire is fitted to a standard rim and a normal internal pressure is applied, wherein the standard dimensions, the standard rim, and the normal internal pressure are as defined by the JATMA standards, the ETRTO standards, or the TRA standards;
a tread ground contact width at 60% of a design load where the tire is fitted to said standard rim and where said normal internal pressure is applied falls within a range from 60% to 75% of the total width of the pneumatic tire excluding the projections, wherein the total width is measured at 60% of a design load where the tire is fitted to the standard rim and the normal internal pressure is applied, and where the standard dimensions, the standard rim, and the normal internal pressure are as defined by the JATMA standards, ETRTO standards or the TRA standards,
wherein the projections are exclusively provided on one side surface of the pneumatic tire in the tire width direction, which becomes an inner side in a width direction of a vehicle when the pneumatic tire is fitted to the vehicle, and
wherein a plurality of recesses being provided on one side surface of the pneumatic tire in the tire width direction, which becomes an outer side in the width direction of the vehicle when the pneumatic tire is fitted to the vehicle.
